(19) United States
(12) Patent Application Publication
(10) Pub. No.: US 2016/0275879 A1
(43) Pub. Date: Sep. 22, 2016

(54) AUGMENTING CONTENT FOR ELECTRONIC PAPER DISPLAY DEVICES

(71) Applicant: Microsoft Technology Licensing, LLC, Redmond, WA (US)

(72) Inventors: Stephen Edward Hodges, Cambridge (GB); John Franciscus Marie Helmes, Steyl (NL); James Scott, Cambridge (GB); Nicholas Yen-Cherng Chen, Cambridge (GB); Stuart Taylor, Cambridge (GB)

(21) Appl. No.: 14/664,639

(22) Filed: Mar. 20, 2015

(51) Int. Cl. G09G 3/34; G09G 3/20

(52) U.S. Cl. CPC G09G 3/3433; G09G 3/2092; G09G 2380/02; G09G 2330/02

(57) ABSTRACT

A computer implemented method of processing content for display on an electronic paper display comprises generating both an image representing a piece of content stored in a content store and a token providing access to the piece of content in the content store. The image and the token are then transmitted to a display device comprising the electronic paper display directly or via one or more intermediary devices.

### BACKGROUND

Electronic paper (or e-paper) is commonly used for e-reader devices because it only requires power to change the image displayed and does not require continuous power to maintain the display in between. The electronic paper can therefore hold static images or text for long periods of time (e.g. from several minutes to several hours and even several days, weeks or months in some examples) without requiring significant power (e.g. without any power supply or with only minimal power consumption). There are a number of different technologies which are used to provide the display, including electrophoretic displays and electro-wetting displays. Many types of electronic paper displays are also referred to as ‘bi-stable’ displays because they use a mechanism in which a pixel can move between stable states (e.g. a black state and a white state) when powered but holds its state when power is removed.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A computer implemented method of processing content for display on an electronic paper display comprises generating both an image representing a piece of content stored in a content store and a token providing access to the piece of content in the content store. The image and the token are then transmitted to a display device comprising the electronic paper display directly or via one or more intermediary devices. In various examples the electronic paper display is a multi-stable display. In various examples, the token is a permission token which grants access to the piece of the content in the content store.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is schematic diagram of an example system comprising a content augmenting service, display device and printer device;

FIG. 2 is a schematic diagram showing three example embodiments of the display device from FIG. 1 in more detail;

FIG. 3 is a schematic diagram showing the printer device from FIG. 1 in more detail;

FIG. 4 is a flow diagram showing an example method of operation of the content augmenting service shown in FIG. 1;

FIG. 5 is a flow diagram showing an example method of modifying content;

FIG. 6 shows two examples of how content may be modified using the method of FIG. 5;

FIG. 7 shows two further examples of how content may be modified using the method of FIG. 5; and

FIG. 8 illustrates various components of an exemplary computing-based device which may run the content augmenting service shown in FIG. 1.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

As described above, current e-reader devices often use a bi-stable display because they have much lower power consumption than backlit LCD/LED displays which require power to be able to display anything. In contrast, a bi-stable display requires power to change state (i.e. change the image/text displayed) but not to maintain a static display. However, despite the difference in display technologies used by e-reader devices and tablet computers, the hardware architecture is very similar. Both types of device contain a battery, a processor, a communications module (which is usually wireless) and user interaction hardware (e.g. to provide a touch-sensitive screen and one or more physical controls such as buttons).

Whilst bi-stable displays have a lower power consumption, they have physical, material and optical characteristics which can mean that content intended for a backlit LCD/LED display or traditional physical print to paper does not look optimal (e.g. it may be displayed at lower resolution, in black and white or greyscale instead of color, etc. or it may be only a single image representing a video, gallery of images or document comprising more rich data such as track change data and/or added comments). Additionally, unless the display device comprises a battery, processor and user input device to enable the displayed image to be changed (as in current e-reader devices), the interactivity of the display device is limited.

The embodiments described below are not limited to implementations which solve any or all of the disadvantages of known ways of providing content to display devices.

Described herein is a method of augmenting content which is to be displayed (i.e. rendered) on a display device which comprises an electronic paper display. As described in more detail below, an image which represents a piece of stored content is generated along with a token for the stored copy of the complete content. Both the image and the token are then transmitted to an intermediary device for uploading to the display device comprising the electronic paper display. Once uploaded, the image is rendered on the electronic paper display and the token is made accessible using a proximity based networking technology implemented within the display device. This may, for example, comprise storing the token on an NFC tag within the display device (so that it can be read by a separate NFC reader device) or rendering a QR (or other visual) code on the electronic paper display (e.g. adjacent to or overlaid upon the image) which encodes the token. The token for the stored copy of the complete content enables a user to access the stored copy and may, for example, comprise a URL which identifies the location of the stored copy. In various examples, the token may provide some form of access rights and so may be referred to as a ‘permission token’.

The method may therefore enable the display device to act as a physical token to access the underlying document if the display device is physically given or lent to someone else. The method may allow the person who triggered the uploading (or “printing”) of the content to the display device to quickly retrieve the underlying document, i.e. as a shortcut or index. The method may allow different devices to write and later read the document—in effect providing a document syncing/transfer service for a user. The method may avoid a user having to store the whole document on the display device, which requires expensive storage (and which cannot be easily deleted remotely where the display device does not comprise a battery capable of updating the electronic paper display thereby compromising privacy). The method may avoid a user having to wait while the whole document is uploaded onto the physical display device.

The term ‘electronic paper’ is used herein to refer to display technologies which reflect light (like paper) instead of emitting light like conventional LCD displays. As they are reflective, electronic paper displays do not require a significant amount of power to maintain an image on the display and so may be described as persistent displays. A multi-stable display is an example of an electronic paper display. In some display devices, an electronic paper display may be used together with light generation in order to enable a user to more easily read the display when ambient light levels are too low (e.g. when it is dark). In such examples, the light generation is used to illuminate the electronic paper display to improve its visibility rather than being part of the image display mechanism and the electronic paper does not require light to be emitted in order to function.

The term ‘multi-stable display’ is used herein to describe a display which comprises pixels that can move between two or more stable states (e.g. a black state and a white state and/or a series of grey or colored states). Bi-stable displays, which comprise pixels having two stable states, are therefore examples of multi-stable displays. A multi-stable display can be updated when powered, but holds a static image when not powered and as a result can display static images for long periods of time with minimal or no external power. Consequently, a multi-stable display may also be referred to as a ‘persistent display’ or ‘persistently stable’ display.

The electronic paper displays described herein are reflective bit-mapped/pixelated displays which provide a 2D grid of pixels to enable, arbitrary content to be displayed. Such displays are distinct from segmented displays in which there are a small number of segments and only pre-defined content can be displayed.

In various examples, the display devices 106 described below may be described as ‘non-networked displays’ because whilst they can maintain an image without requiring significant power, they have no automatic means of updating their content other than via the method described herein.

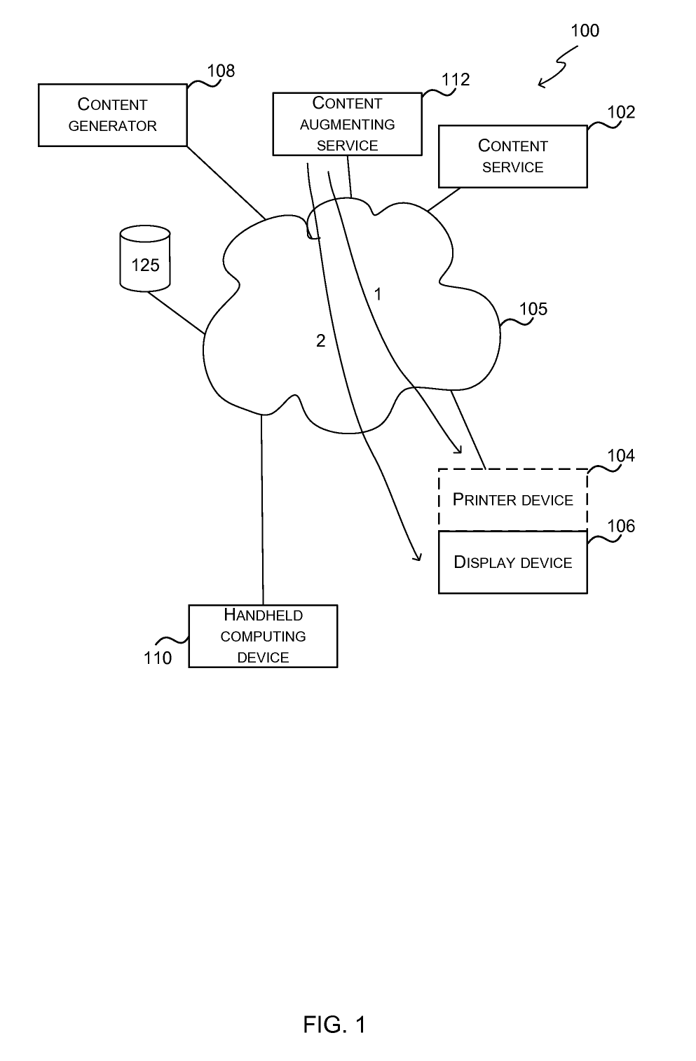

FIG. 1 is schematic diagram of an example system 100 which comprises a content generator device 108 (which generates content, e.g. under the control of a user), a content service 102 (which provides generated content to a display device 106) and a printer device 104 which can communicate via a network 105 (e.g. the internet) and which uploads content received from the content service 102 onto the display device 106 (which comprises a electronic paper display) when the display device 106 is brought into contact with the printer device 104. The content which is generated by the content generator 108 may be stored in an accessible location connected to the network 105 (e.g. in a cloud-based content store 125).

Whilst the content generator 108 and content service 102 are shown separately in FIG. 1, in some examples, the content service 102 may also act as the content generator device 108 (e.g. a single application may enable a user to generate, or compile, content and then trigger the sending of a representative image and permission token for the content for uploading to a display device comprising an electronic paper display). Additionally, although the content store 125 is shown separately from both the content generator 108 and the content service 102, in some examples, the content store 125 may be collocated with the content generator 108 (e.g. it may be part of the content generator device 108) and/or the content service 102 (e.g. it may be part of the device which runs the content service). In an example, an application running on the handheld computing device 110 may act as the content generator 108, content augmenting service 112 and content service 102 and a memory on the handheld computing device 110 may be the content store 125. Furthermore, although FIG. 1 shows a single content store 125, it will be appreciated that there may be more than one content store (e.g. a content store on the content generator 108, a separate content store, a content store on the handheld computing device 110, etc.).

The display device 106 (which includes the electronic paper display) shown in FIG. 1 does not include a battery (or other power source) which provides sufficient power to update the electronic paper display. Instead, power to update the electronic paper display is provided to the display device via a contact based conductive digital data and power bus from an intermediary device (which may be referred to as a ‘printer device’) when the display device is touched against the printer device. The digital data and power bus is described as being contact based and conductive because signals for the digital data and power bus are not provided via a cable (which may be flexible), but instead the display device comprises a plurality of conductive contacts (e.g. metal contacts) on its housing (e.g. on an exterior face of the housing) which can be contacted against a corresponding set of conductive contacts on the housing of a printer device. For example, the plurality of conductive contacts may be on a visible face of the display device (e.g. the front, back or side of the printer device) and may be contacted against a corresponding set of conductive contacts on a visible face of the printer device. In other examples, the plurality of conductive contacts may not be visible and may instead be located within a recess (e.g. a slot) on the printer device, such that an edge of the display device is pushed into the recess so that the contacts on the printer and display devices can make contact with each other. The display device is not permanently connected to a printer device but is, instead, intermittently connected (e.g. hourly, daily, weekly, etc. depending on when new content is desired or available).

It will be appreciated that the system may alternatively comprise a display device which does include a battery (or other power source) which provides sufficient power to update the electronic paper display. In such examples, the printer device 104 shown in FIG. 1 may be omitted and the content may be transmitted directly to the display device for rendering.

A content augmenting service 112 is described herein which runs on a computing device which is separate from (and may also be remote from) the display device 106. The content augmenting service may, for example, run on the content generator device 108, printer device 104, or may be integrated with the content service 102 or run on a separate computing device, such as handheld computing device 110 (e.g. a tablet or smartphone), a wearable device (e.g. a smart watch or head-mounted device), an augmented reality device, etc. The content augmenting service generates an image for display on the display device 106 and the image which is generated represents a piece of stored content in the content store 125, for example, the image which is generated may correspond to a portion of a content item stored in the content store 125. In addition to generating the image, the content augmenting service also generates a token (e.g. a permission token) for the content item stored in the content store 125 (e.g. a username and password or other credentials). The permission token may allow read and/or write access and may have one or more additional conditions attached to it (e.g. an expiry date/time, a limit on the number of times the content can be accessed, a list of specific users who are authorized to utilize the permission token, etc.).

The permission token for a content item may be of any suitable form. For example, it may a username and password or other credentials. In various examples it may be a globally unique identifier (GUID) or a concatenation of one or more of the content store ID, an access permission and a digital signature (so that the access permission cannot be forged). In other examples, the permission token may be digitally signed using a private key so recipients can guarantee its authenticity by decoding it with a known public key. In some examples, a GUID may be used which links to a permission database as this enables the permission to be constrained (e.g. such that it has an expiry date) or enables the permission to be changed or revoked after the permission token has been generated and uploaded to a display device.

In various examples, the token or permission token (once generated) may be encapsulated into a URL which includes details of where the permission token should be presented to gain access to the content (although as described above, this location information may be part of the token rather than being added to the token when encapsulating the token into a URL). Use of a URL enables a standard web browser to understand what to do with the token, alternatively another standard format may be used or a custom application may be used to access the content using a generated token. This URL may then be further encapsulated into an NDEF (NFC Forum Data Format) message which is a standard NFC format for supplying URLs to devices such as smart phones. In addition, or instead, the NDEF message may encapsulate the token which may, for example, trigger the launching of a specified application on a receiving computing device and provides that application with the token. In various examples the NDEF message may also encode additional information such as the ID for the display device and security parameters for the display device (e.g. such that an application or website that receives the NDEF message receives all the necessary information not only to enable the user to read/consume the content but also to write content to the particular display device).

Having generated both the image and the token (e.g. the permission token), the two items are both transmitted for uploading to the display device 106. Depending upon where in the system 100 the content augmenting service 112 is implemented, the two items may be transmitted to an intermediary device for uploading to the display device 106, where this intermediary device may be the printer device 104 or the content service 102. For example, where the content augmenting service 112 is run on the content generator device 108 the two items may be transmitted to the content service 102 for uploading to the display device 106. Where the display device 106 can only receive content from a printer device 104, the two items may be transmitted to the printer device 104 for uploading and in such an example, the content augmenting service 112 may transmit the two items to the printer device 104 directly (e.g. where the content augmenting service is integrated with the content service) or via the content service 102 (where the content augmenting service is separate from the content service). Alternatively, where the content augmenting service 112 is run on the printer device 104 (for a display device 106 which requires power from the printer device 104 to update the electronic paper display), there is no intermediary device and the two items are uploaded directly to the display device 106. Similarly, in the event that the display device 106 comprises a power source which is capable of updating the electronic paper display and where the content augmenting service 112 is integrated within (or running on the same computing device as) the content service 102, there is no intermediary device and the two items may be uploaded directly to the display device.

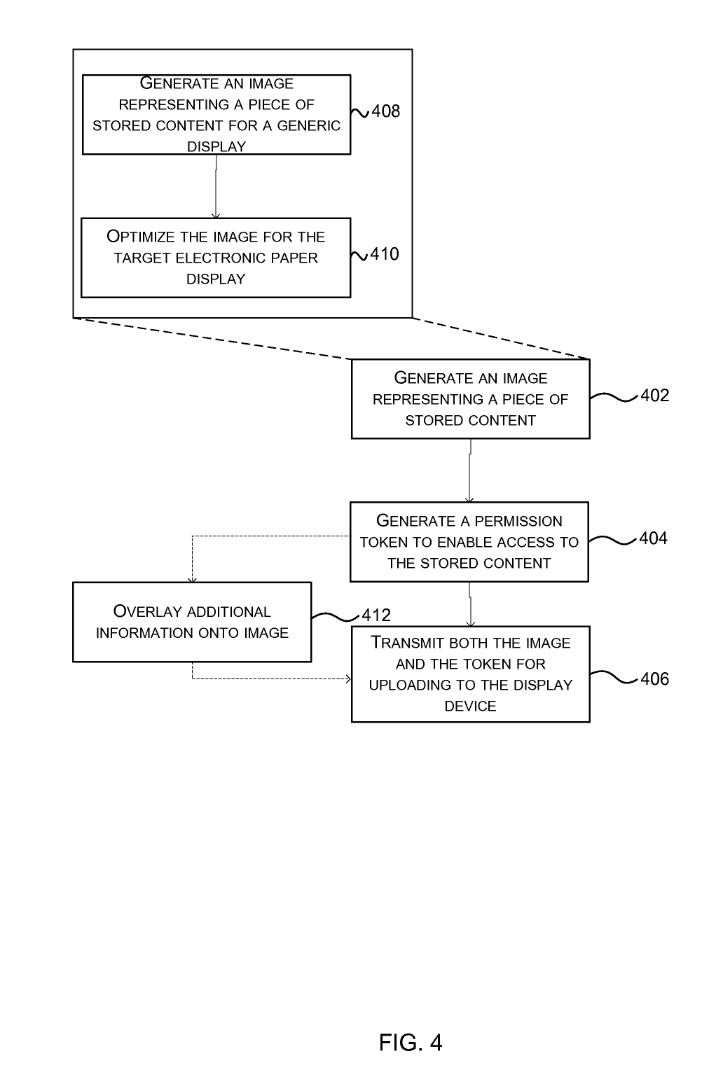

Operation of the content augmenting service 112 is described in more detail below with reference to FIG. 4 and in the following description references to the token being a permission token is by way of example and it will be appreciated that the token may, in some examples, comprise a link to the stored content which may be stored in an accessible location and so not require any associated permissions (e.g. access rights).

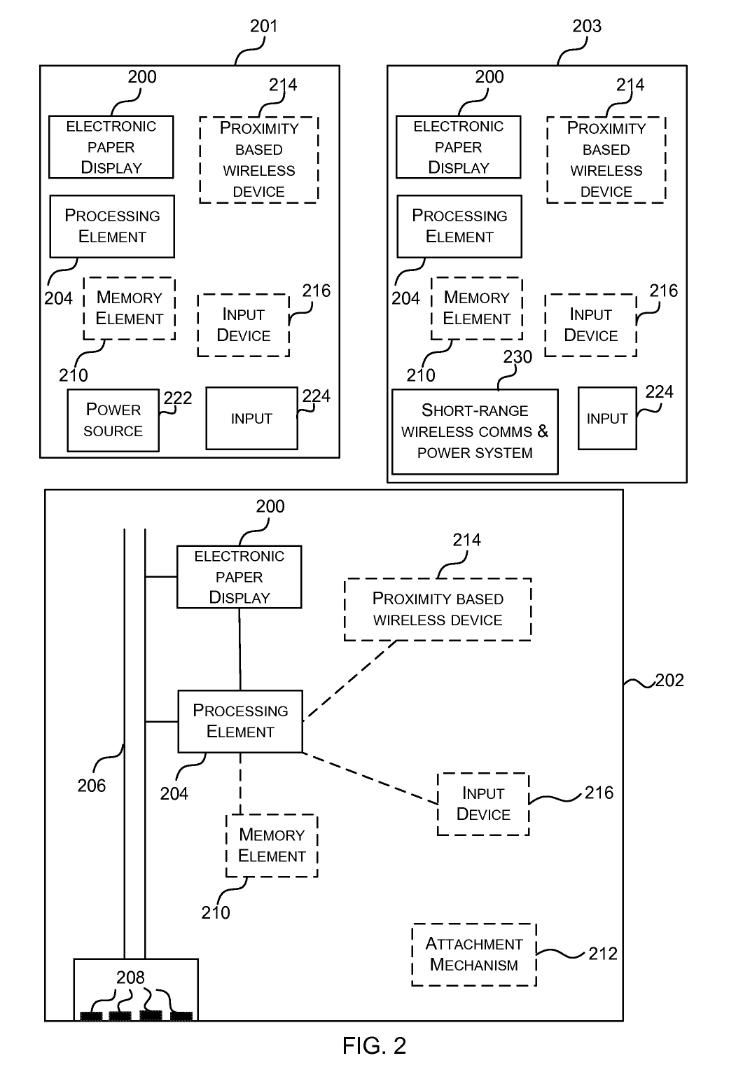

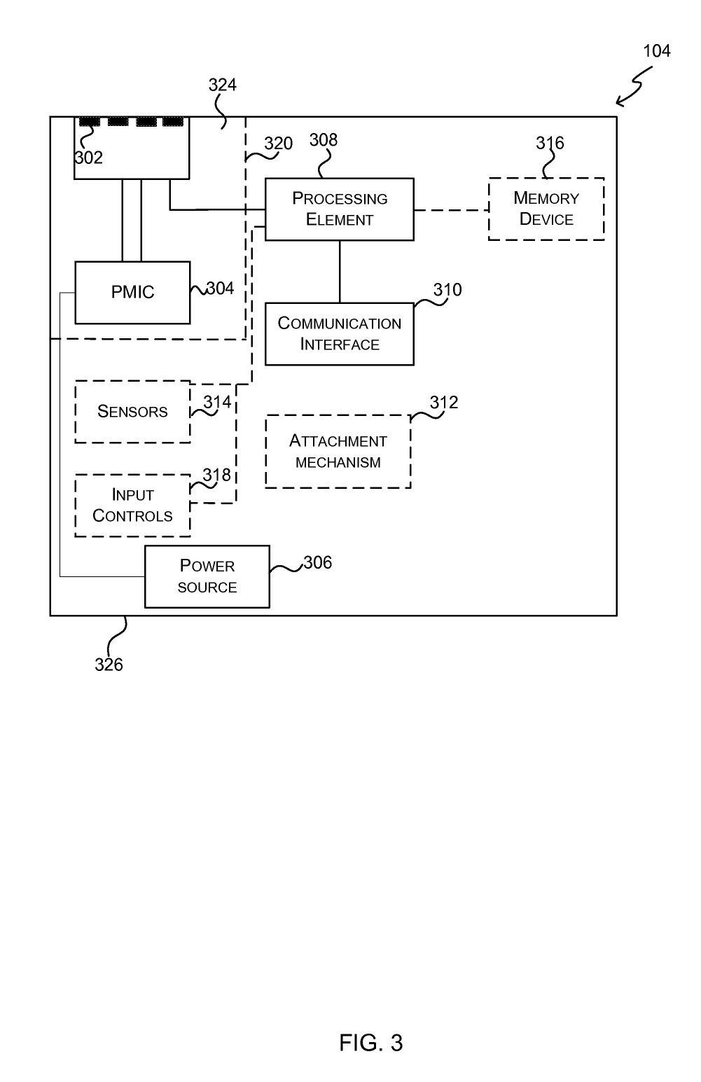

FIG. 2 is a schematic diagram showing three example implementations of the display device 106 from system 100 in more detail. In the first example the display device 201 includes a power source 222 which is capable of updating the electronic paper display and in the second and third examples the display device 202, 203 does not include a power source which is capable of updating the electronic paper display and hence requires a printer device 104 as shown in FIG. 3.

The display device 201-203 comprises an electronic paper display 200, a processing element 204 and an input 224, 208 for receiving updated content for display on the electronic paper display. The second example 202 additionally comprises a contact based conductive digital data and power bus 206. As described above, the bus 206 connects the processing element 204 to a plurality of conductive contacts 208 on the exterior of the housing of the display device 106 (and which therefore comprise the input for receiving updated content). The display device 106 does not comprise a power source which is capable of updating the electronic paper display and power for updating the electronic paper display is instead provided via the bus from a power source 306 in the printer device 104. The third example 203 additionally comprises a short range (e.g. sub-30 cm) wireless communication and power system 230 which is capable of harvesting power from a proximate device (e.g. using NFC) but does not require the two devices to be in physical contact (as is the case in the second example which only receives power for updating the electronic paper display via the contact based conductive digital data and power bus 206). In a further variation, not shown in FIG. 2, the display device 106 may receive power via a wired connection (e.g. a USB connection) from a separate printer device, where the wired connection may be via a flexible cable or a rigid connector which is integrated with the display device.

The electronic paper display 200 may use any suitable technology, including, but not limited to: electrophoretic displays (EPDs), electro-wetting displays, bi-stable cholesteric displays, electrochromic displays, MEMS-based displays, etc. and some of these technologies may provide multi-stable displays. In various examples, the display has a planar rectangular form factor; however, in other examples the electronic paper display 200 may be of any shape and in some examples may not be planar but instead may be curved or otherwise shaped (e.g. to form a wearable wrist-band) or any combination thereof. In various examples, the electronic paper display 200 may be formed on a plastic substrate which may result in a display device 201-203 which is thin (e.g. less than one millimeter thick) and has some flexibility. Use of a plastic substrate makes the display device 201-203 lighter, more robust and less prone to cracking of the display (e.g. compared to displays formed on a rigid substrate such as silicon or glass).

The processing element 204 may comprise any form of active (i.e. powered) sequential logic (i.e. logic which has state), such as a microprocessor, microcontroller, shift register or any other suitable type of processor for processing computer executable instructions to drive the electronic paper display 200. The processing element 204 comprises at least the row & column drivers for the electronic paper display 200; however, in various examples, the processing element 204 comprises additional functionality/capability. For example, the processing element 204 may be configured to demultiplex data received (e.g. via the input 222, the bus 206 or short-range wireless communication and power system 230) and drive the display 200.

In various examples the processing element 204 may comprise one or more hardware logic components, such as Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs) and Graphics Processing Units (GPUs).

In various examples, the processing element 204 may comprise (or be in communication with) a memory element 210 which is capable of storing data for at least a sub-area of the display 200 (e.g. one row and column of data for the display 200) and which in some examples may cache more display data. In various examples the memory element 210 may be a full framebuffer to which data for each pixel is written before the processing element 204 uses it to drive the row/column drivers for the electronic paper display. In other examples, the electronic paper display may comprise a first display region and a second display region which may be updated separately (e.g. the second display region may be used to show icons or user-specific content) and the memory element may be capable of storing data for each pixel in one of the display regions.

In various examples, the memory element 210 may store other data in addition to data for at least a sub-area of the display 200 (e.g. one row and column of the display). In various examples, the memory element 210 may store an identifier (ID) for the display device 201-203. This may be a fixed ID such as a unique ID for the display device 201-203 (and therefore distinct from the IDs of all other display devices 201-203) or a type ID for the display device (e.g. where the type may be based on a particular build design or standard, electronic paper display technology used, etc.). In other examples, the ID may be a temporary ID, such as an ID for the particular session (where a session corresponds to a period of time when the display device is continuously connected to a particular printer device) or for the particular content being displayed on the display device (where the ID may relate to a single page of content or a set of pages of content or a particular content source). In various examples, a temporary ID may be reset manually (e.g. in response to a user input) or automatically in order that a content service does not associate past printout events on a display device with current (and future) printouts, e.g. to disable the ability for a user to find out the history of what was displayed on a display device which might, for example, be used when the display device is given to another user. The ID which is stored may, for example, be used to determine what content is displayed on the display device and/or how that content is displayed (as described in more detail below).

In various examples, the memory element 210 may store parameters relating to the electronic paper display 200 such as one or more of: details of the voltages required to drive it (e.g. the precise value of a fixed common voltage, Vcom, which is required to operate the electronic paper display), the size and/or the resolution of the display (e.g. number of pixels, pixel size or dots per inch, number of grey levels or color depth, etc.), temperature compensation curves, age compensation details, update algorithms and/or a sequence of operations to use to update the electronic paper display (which may be referred to as the ‘waveform file’), a number of update cycles experienced, other physical parameters of the electronic paper display (e.g. location, orientation, position of the display relative to the device casing or conductive contacts), the size of the memory element, parameters to use when communicating with the electronic paper display, etc. These parameters may be referred to collectively as ‘operational parameters’ for the electronic paper display. The memory element 210 may also store other parameters which do not relate to the operation of the electronic paper display 200 (and so may be referred to as ‘non-operational parameters’) such as a manufacturing date, version, a color of a bezel of the display device, etc.

Where the memory element 210 stores an ID or parameters for the electronic paper display, any or all of the stored ID and parameters may, the second example 202, be communicated to a connected printer device 104 via the bus 206 and contacts 208 by the processing element 204. The printer device 104 may then use the data received to change its operation (e.g. the voltages provided via the bus or the particular content provided for rendering on the display) and/or to check the identity of the display device 106. In any of the three examples, the ID may be communicated to the content service 102 as described in more detail below.

In various examples, the memory element 210 may store computer executable instructions which are executed by the processing element 204 (e.g. when power is provided via the bus 206 in the second example 202 or the short-range wireless communication and power system 230 in the third example 203). The memory element 210 includes volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media.

In various examples, the second example display device 202 may further comprise an attachment mechanism 212 which is configured to hold the display device 202 in contact with a printer device when a user has brought the two devices into contact with each other. This attachment mechanism 212 may, for example, use one or more ferromagnetic elements in one or both of the display device 202 and the printer device 104. In addition to, or instead of, using ferromagnetic elements, the attachment mechanism may use suction cup tape, friction (e.g. with the display device being partially inserted into a slot or recess on the printer device) or a clamping arrangement.

In various examples, the display device 201-203 may further comprise a proximity based wireless device 214, such as a near field communication (NFC) device and in the third example, the proximity based wireless device 214 may be part of (or comprise) the short range wireless communication and power system 230. The proximity based wireless device 214 comprises a data communication interface (e.g. an VC interface, SPI, an asynchronous serial interface, etc.) and an antenna and may also comprise a memory device. The memory in the proximity based wireless device 214 (or memory element 210) may be used to store the permission token generated by the content augmenting service 112 (and received via the printer device 104) and which enables a user to access the content stored in the content store 125. The stored token may be read (via the antenna) by another proximity based wireless device which is in proximity to the display device 201-203 (e.g. an NFC reader which may be integrated within a handheld computing device 110 or printer device 104). In addition, the memory in the proximity based wireless device 214 may store an identifier (ID) which may be fixed or dynamic (or may comprise a fixed element and a dynamic element which may be stored in the same memory device or separately) and the ID may comprise one or more elements: an element that is fixed and correspond to an ID for the display device 201-203 and/or an element that is dynamic and correspond to the content currently being displayed on the display device 201-203 or a current session/instance ID (i.e. it may be a fixed device ID or a dynamic content ID). Where the ID (or part thereof) is a content ID or an instance ID, this may be written by the processing element 204 whenever new content is rendered on the display. Where the ID is a session ID, this may be written by the processing element 204 at the start of each new session (e.g. when the processing element switches on). In other examples, the memory may be used to store operational parameters for the display device (e.g. as described above).

Where the second example display device 202 shown in FIG. 2 comprises a proximity based wireless device 214, this wireless device is not used to provide power to update the electronic paper display (i.e. energy harvesting is not used to provide power to update the electronic paper display in the second example 202).

In various examples, the display device 201-203 may further comprise one or more input devices 216. An input device 216 may, for example, be a sensor (such as a microphone, touch sensor or accelerometer) or button. In the second and third examples, 202, 203, such input devices 216 are only operational (i.e. powered) when the display device 202 is in contact with a printer device 104 such that power is provided via the bus 206 or when the display device 203 is receiving power via the short-range wireless communication and power system 230. Where the display device 106 comprises an input device 216, signals generated by the input device 216 may be interpreted by the processing element 204 and/or communicated to a remote processing device (e.g. in a printer device 104 in the case of the second example 202). User inputs via an input device 216 may, for example, be used to modify the content displayed on the electronic paper display 200 (e.g. to annotate it, change the font size, trigger the next page of content to be displayed, etc.) or to trigger an action in a remote computing device.

In an example, the display device 201-203 comprises an input device 216 which is a touch-sensitive overlay for the electronic paper display 200. The touch-sensitive overlay may, for example, use pressure, capacitive or resistive touch-sensing techniques. In the second and third examples, when the display device 202, 203 is powered via the bus (i.e. when it is in contact with a printer device 104) or the short-range wireless communication and power system 230, the touch-sensitive overlay may be active and capable of detecting touch events (e.g. as made by a user's finger or a stylus touching the electronic paper display 200). In the first example 201 the overlay may be active at any time. The output of the touch-sensitive overlay is communicated to the processing element 204 or printer device 104 (in the second example 202) or content service which may modify the displayed image (on the electronic paper display 200) to show marks/annotations which correspond to the touch events. In other examples, the processing element 204 may modify the displayed image in other ways based on the detected touch-events (e.g. through the detection of gestures which may, for example, cause a zoom effect on the displayed content).

In another example, the display device 201-203 comprises an input device 216 which is a microphone. The microphone detects sounds, including speech of a user and these captured sounds may be detected by the processing element 204 or printer device (in the second example) or content service and translated into changes to the displayed image (e.g. to add annotations or otherwise change the displayed content). For example, simple keyword detection may be performed on the processing element to cause it to fetch content from memory and write it to the electronic paper display. In another example, the processing element may interpret or transform the audio data and ship it out to the printer device or a remote server for more sophisticated processing. In another example, the recorded sounds (e.g. speech waveform) may be recorded and stored remotely (e.g. in a content service) associated with the ID of the display device and a visual indication may be added to the displayed content so that the user knows (e.g. when they view the same content later on) that there is an audio annotation for the content.

In various examples, the display device 201-203 may comprise a touch-sensitive overlay and a microphone which operate in combination to enable a user to use touch (e.g. with a finger or stylus) to identify the part of an image (or other displayed content) to annotate and then their voice to provide the annotation (as captured via the microphone). In such an example, the spoken words may be text to add to the displayed content or commands (e.g. “delete this entry”).

Where provided, the printer device 104, as shown in FIG. 3, comprises a plurality of conductive contacts 302 and a power management IC (PMIC) 304 which generates the voltages that are provided to the bus of the display device (via contacts 302). The PMIC 304 is connected to a power source 306 which may comprise a battery (or other local power store, such as a fuel cell or supercapacitor) and/or a connection to an external power source. Alternatively, the printer device 104 may use an energy harvesting mechanism (e.g. a vibration harvester or solar cell).

The printer device 104 further comprises a processing element 308 which provides the data for the bus of the display device, including the pixel data. The processing element 308 in the printer device 104 obtains content for display from the content service 102 via a communication interface 310 and may also obtain one or more operational parameters for different display devices from the content service 102. The communication interface 310 may use any communication protocol and in various examples, wireless protocols such as Bluetooth™ or WiFi™ or cellular protocols (e.g. 3G or 4G) may be used and/or wired protocols such as USB or Ethernet may be used. In some examples, such as where the communication interface uses USB, the communication interface 310 may be integrated with the power source 306 as a physical connection to the printer device 104 may provide both power and data.

The processing element 308 may, for example, be a microprocessor, controller or any other suitable type of processor for processing computer executable instructions to control the operation of the printer device in order to output pixel data to a connected display device 106. In some examples, for example where a system on a chip architecture is used, the processing element 308 may include one or more fixed function blocks (also referred to as accelerators) which implement a part of the method of providing pixel data in hardware (rather than software or firmware). The processing element 308 may comprise one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The printer device 104 may comprise an attachment mechanism 312, such as one or more ferromagnetic elements or a slot to retain the display device. This attachment mechanism 312 may, in various examples, incorporate a sensor 314 (which may be implemented as a sensing electronic circuit) to enable the printer device 104 to determine the orientation of a display device when in contact with the printer device 104 and/or whether a display device is in contact or not.

In various examples, the processing element 308 may comprise (or be in communication with) a memory device (or element) 316. In various examples, the memory element 316 may store an identifier (ID) for the printer device 104. This may be a fixed ID such as a unique ID for the printer device 104 (and therefore distinct from the IDs of all other printer devices 104) or a type ID for the printer device (e.g. where the type may be based on a particular build design or standard, etc.). In other examples, the ID may be a temporary ID, such as an ID for the particular session (where a session corresponds to a period of time when the display device is continuously connected to a particular printer device) or for the particular content being displayed on a connected display device (where the ID may relate to a single page of content or a set of pages of content or a particular content source).

In various examples, the memory element 316 may store operational parameters for one or more different electronic paper displays, where these operational parameters may be indexed (or identified) using an ID for the display device (e.g. a unique ID or a type ID). Where operational parameters are stored in the memory element 316 these may be copies of parameters which are stored on the display device, or they may be different parameters (e.g. voltages may be stored on the display device and a waveform for driving the display device may be stored on the printer device because it occupies more memory than the voltages) or there may not be any operational parameters stored on the display device. In addition, or instead, the memory element may store parameters associated with printer device, such as its location (e.g. kitchen, bedroom, etc.) and additional connected devices (e.g. a music player through which audio can be played, etc.).

In various examples, the memory element 316 may act as a cache for the content (or image data) to be displayed on a connected display device. This may, for example, enable content to be rendered more quickly to a connected device (e.g. as any delay in accessing the content service 102 may be hidden as pages are cached locally in the memory element 316 and can be rendered whilst other pages are being accessed from the content service 102) and/or enable a small amount of content to be rendered even if the printer device 104 cannot connect to the content service 102 (e.g. in the event of connectivity/network problems).

The memory element 316 may, in various examples, store computer executable instructions for execution by the processing element 308. The memory element 316 may include volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 316) is shown within the printer device 104 it will be appreciated that the storage may be distributed or located remotely and accessed via a network or other communication link (e.g. using communication interface 310).

As described above, the printer device 104 may comprise a sensor 314 configured to detect whether a display device is in contact with the printer device 104 or is electrically connected via the contacts 302. In addition or instead, one or more other sensors may be provided within the printer device 104, such as an accelerometer (e.g. for sensing motion of or the orientation of the printer device 104) and/or a sensor for detecting a proximate handheld computing device (e.g. a smartphone or tablet computer).

In various examples, the printer device 104 may comprise one or more user input controls 318 which are configured to receive user inputs. These user inputs may, for example, be used to change what is displayed on a connected display device (e.g. to select the next page within a piece of content or the next piece of content). For example, the printer device 104 may comprise one or more physical buttons. In various examples, one or more physical buttons may be provided which are mapped to specific content (e.g. when pressing a particular button, a photo ID badge will always be rendered on the connected display). These buttons may have fixed functions or their functions may change (e.g. based on the content displayed or the display device connected). In some examples, the processing element 308 may render icons adjacent to each button on the electronic paper display, where an icon indicates the function of the adjacent button. In such an example, the pixel data provided to the display device (via contacts 302) is a composite image which combines the content to be displayed and one or more icons for buttons (or other physical controls) on the printer device 104. In other examples, the composite image may be generated by the content service 102.

In an example, the printer device 104 comprises an input control (or device) 318 which detects a user touching a connected display device with their finger or a stylus. This may, for example, comprise an electromagnetic sensing backplane (e.g. using electric field sensing) in the face of the printer device which is adjacent to a connected display device or may be implemented using force sensors (e.g. four sensors at the corners and where interpolation is used to calculate the touch point position) or active digitizer pens. Alternatively, optical or ultrasonic methods may be used (e.g. to look along the top surface). Where ultrasonics are used, these may additionally be used to provide haptic feedback to the user. In various examples, electrostatic feedback may be used. The output of the touch input control is communicated to the processing element 308 or to the content service which may modify the content and then provide the modified content to the display device (so that it is displayed on the electronic paper display 106) to show marks/annotations which correspond to the touch events. In other examples, the processing element 308/content service may modify the displayed image in other ways based on the detected touch-events (e.g. through the detection of gestures which may, for example, cause a zoom effect on the displayed content or through provision of feedback in other ways, e.g. using audio or vibration or by selectively backlighting the electronic paper display using one or more lightpipes).

In various examples, the printer device 104 comprises an input device which is a microphone. The microphone detects sounds, including speech of a user and these captured sounds may be detected by the processing element or content service and translated into changes to the displayed image (e.g. to add annotations or otherwise change the displayed content). In another example, the recorded sounds (e.g. speech waveform) may be recorded and stored remotely (e.g. in a content service) associated with the ID of the display device and a visual indication may be added to the displayed content so that the user knows (e.g. when they view the same content later on) that there is an audio annotation for the content.

In various examples, the printer device 104 may comprise a sensing backplane and a microphone which operate in combination to enable a user to use touch (e.g. with a finger or stylus) to identify the part of an image (or other displayed content) to annotate and then their voice to provide the annotation (as captured via the microphone). In such an example, the spoken words may be text to add to the displayed content or commands (e.g. “delete this entry”).

The printer device 104 may have many different form factors. In various examples it is standalone device which comprises a processing element 308 and communication interface 310 in addition to a PMIC 304 and a plurality of conductive contacts 302 to provide the signals for the digital data and power bus 206 within a display device. In other examples, however, it may be a peripheral for a computing device and may utilize existing functionality within that computing device which may, for example, be a portable or handheld computing device (e.g. a smartphone, tablet computer, handheld games console, etc.) or a larger computing device (e.g. a desktop computer or non-handheld games console). Where the printing device 104 is implemented as a peripheral device, the functionality shown in FIG. 3 may be split along the dotted line 320 such that the PMIC 304 and conductive contacts 302 are within the peripheral 324 and the remaining elements (in portion 326) are within the computing device and may utilize existing elements within that computing device. In further examples, the entire printer device 104 may be integrated within a computing device.

FIG. 4 is a flow diagram showing an example method of operation of the content augmenting service 112 shown in FIG. 1. The method comprises generating an image corresponding to a portion of a piece of content stored in the content store 125 (block 402), generating a permission token enabling access to the stored piece of content in the content store 125 (block 404) and transmitting both the image and the token for uploading to a display device 106, 201-203 comprising an electronic paper display (block 406). As described above, the image and the token may be transmitted to the printer device 104 (arrow 1 in FIG. 1) or directly to the display device (arrow 2 in FIG. 1, e.g. where there is no printer device 104) and although not shown in FIG. 1, the transmission may be via another entity such as the content service 102.

The image which is generated by the content augmenting service 112 (in block 402) may be a representative image for the stored content. For example, where the stored content is too large to be displayed in a single page on the display device 106 (e.g. because it comprises multiple pages or would need to be truncated and rendered over several pages), the image which is generated may be the first (or front) page of the stored content (e.g. showing the title and the start of the text). Where the stored content is a slideshow or album of photographs, the image which is generated may be the first image in the content or a representative image which is selected by the content augmenting service 112 from all the images in the stored content (e.g. using image analysis techniques to select an image which is representative of all the images in the stored content). In some examples, the stored content may not be suitable for consuming visually (e.g. it may be an audio file such as a music track) and in such examples, the image may be generated to represent the content visually (e.g. in the form of an image of the album cover) but may not be part of the stored content. In various examples, generating an image representing a piece of stored content (in block 402) may comprise accessing a remote database and retrieving a suitable image (e.g. album art for a music track).

In various examples, the image which is generated (in block 402) may be optimized for the particular electronic paper display (or type of electronic paper display) on which it is to be rendered and/or a user of the target display. In such an example, the content augmenting service 112 may first generate a generic representative image (block 408) and may then optimize that image for display on the particular target electronic paper display (block 410). There are many different ways in which the image may be optimized (in block 410) and various examples are described below. Parameters associated with the target display may, for example, be identified based on an ID for the target display (e.g. as described above) and/or these parameters may be accessed from the target device itself. These parameters may relate to the specific target device (as described above) and in addition one or more parameters may be modified for a particular user of the target device (e.g. for a user who requires larger text to be able to read it easily). The optimization which is performed may make the image more clearly visible or readable (depending upon whether the image contains text or not). In various examples, the optimization may also enhance the aesthetics, e.g. by making the image background match (or contrast with) a bezel on the display device.

The optimization of the image (in block 410) may not be performed each time an image is generated. In various examples, the optimization may be performed the first time a piece of content is requested and then the resulting content (i.e. the generated, optimized image from block 410) may be cached so that if a request is subsequently received from the same display device or display device with similar characteristics, the cached version may be used to save processing time. In addition or instead, where the parameters are accessed from the target device, these may be cached so that they do not need to be accessed for each new piece of content that is to be uploaded to the same target device.

In various examples, the generation of the image representing a piece of stored content may be performed proactively for one or more types of known display devices when content is first provided. This means that when the content is subsequently requested by a device of one of these known types, there is no delay due to the augmentation process.

In various examples, the generic image (generated in block 408) may be auto-scaled to suit the actual size and/or resolution of the target electronic paper display (e g dimensions of the electronic paper display, number of pixels, size of pixels, dots per inch, etc.).

In various examples, the generic image may also be modified to be in a file format which is most efficient to consume by the display device hardware (or intermediate hardware which in turn transfers the content to the display device). For example, the row/column ordering may be changed so that the data can be directly read into the display device's framebuffer memory without further processing.

In various examples, the generated image may be compressed using a compression method that is chosen based on factors such as (a) low memory and/or processing requirements imposed on the decompression on the display device or intermediary device, (b) existence of support provided for decompression by certain displays/intermediary hardware, (c) whether support for given decompression codecs/image formats is software-based or hardware-accelerated, etc.

In various examples, the content augmentation service may take into account the existing image on the display when optimizing the image (in block 410) in order to optimize the redrawing process when the image is rendered on the display device. For example, if the new display content is only different from the existing content in particular regions of the display, the only those regions could be sent. Furthermore, electronic paper displays typically have multiple “redrawing” modes which trade off accuracy of result versus speed of redraw. Thus, depending on factors such as (a) the previous image and next image, (b) the time since a “full” rather than “partial” redraw was last done, (c) factors affecting the data security requirements of the older image, (e.g. whether the image is marked private, or if the user has set a preference for maximizing data security), full redraws may be done more often/every time, to avoid any chance that the old image may be faintly visible or even invisible but reconstructable by an expect, due to the afterimage effects sometimes seen with electronic paper displays

In various examples, the image may be processed to automatically enhance text either by using image processing on the bitmap (as generated in block 408) or by detecting text and replacing it with a more suitable font type, size, weight, etc. based on knowledge of the target electronic paper display. Where image processing is used, this may, for example, use morphological operators like thinning or growing (also referred to as erosion and dilation respectively). In other examples, other image processing techniques such as convolution with a discrete kernel may be used (e.g. to detect edges in the image and enhance them in some way).

In various examples, the image may be processed by applying graphics filters to enhance graphics, such as to ensure that lines are no narrower than a predefined minimum width for the target electronic paper display device. For example, dithering may be used to convey a greater number of grey levels than an electronic paper display supports natively. Alternatively (and depending on the context), a specific shade of grey may be approximated with the nearest native level to avoid a pattern of isolated ‘dots’.

Although the image processing may be performed with knowledge of the target electronic paper display device as described above, in other examples, image processing may be performed without knowledge of the target electronic paper display. In such examples the image processing may be performed based on generic parameters specified for all electronic paper displays (e g minimum line widths, minimum font sizes, etc.) or for a particular type of electronic paper display.

An example of image processing which may be performed irrespective of the target display device is the removal of elements from an image that were inadvertently captured when an image was generated by a user (e.g. when a photograph was taken or a screenshot captured). For example, when capturing a screenshot the resultant image often includes controls (e.g. on screen buttons) and/or a mouse cursor. These items may be identified within the generated image (e.g. using image matching against a database of application icons, using known locations of the on-screen controls for a particular application or by using techniques to segment the image, for example looking at brightness levels) and then may be removed (e.g. by replacing the pixels with pixels of a background or default color or by cropping the image to eliminate them) by the content augmenting service.

The permission token which is generated by the content augmenting service 112 (in block 404) includes credentials which permit the user to access the stored content (e.g. read and/or write permissions) and various examples are described above. In some examples, the permission token may also encode one or more conditions for the permissions (e.g. time of day, number of times it can be accessed, expiry date, etc.).

In various examples, the content augmenting service 112 may also overlay additional information onto the generated image (block 412). This additional information may be metadata associated with the image (e.g. date of creation, owner of content, etc.) or other information such as a count of the number of times a piece of content has been displayed on a display device 106 or user specified information (e.g. a comment or title for the image). In various examples, the metadata may be generated by performing optical character recognition (OCR) on any text in the image (or in the content) and the metadata may be the resulting text. The method may therefore comprise generating the additional information and then overlaying the generated additional information. In various examples, the overlaid information may encode the permission token (as generated in block 404), e.g. in the form of a QR code or other visual code.

The additional information which is overlaid (in block 412) onto the original image (generated in block 402) may be placed on top of the original image or alongside (i.e. adjacent to) the original image. For example, the additional information may be overlaid on a single part of the image, (e.g. the top-right corner). The position of the overlay may be chosen automatically based on where there is little to obscure (e.g. by selecting one of the four quadrants of the image based on image entropy). In various examples, the information to be overlaid may be placed next to relevant visual content (e.g. putting the name of a celebrity in the photo next to their face). In various examples, the additional information may be split into different pieces which are overlaid in different places. The overlay may, in various examples, be partially ‘transparent’, i.e. blended with the image behind it so as not to completely obscure the image.

The transferring (e.g. uploading) of the image and the permission token to the display device 106 may, as described above, be performed using any suitable technology. In a first example implementation, both the image and the permission token may be uploaded via a wireless link to the display device. In a second example implementation, a printer device 104 may upload the image to the display device 106 via the contact-based bus when the display device 106 is brought into contact with the printer device 104 and the permission token may be uploaded separately (e.g. via a wireless link). In a third example implementation, both the image and the permission token may be uploaded by a printer device 104 to the display device 106 via the contact-based bus when the display device 106 is brought into contact with the printer device 104.

In any of these examples, following the uploading, the image is rendered on the electronic paper display in the display device and the permission token is made available to users with a computing device (e.g. handheld computing device 110) which is brought into proximity with the display device 106. As described above, the permission token may be made available via an NFC tag within the display device 106 or the permission token may be rendered on the electronic paper display (e.g. in the form of a QR code or other visual code). In other examples, other forms of RFID may be used instead of NFC (e.g. surface acoustic wave tagging, magnetic tagging, etc.) or other forms of optical tagging may be used (e.g. using re-programmable MEMs mirror arrays or re-writable holographic tags).

For example, a user may receive the image and the permission token on their display device 106 when they bring it into contact with a printer device 104. The image may, for example, be a single image from an album of images (e.g. holiday photos of a friend) and the permission token may grant the user read only rights to the album which is stored in the online content store 125. To view the album, the user uses another computing device (e.g. their smartphone) to read the permission token from the display device and this may be done at any time after the display device has been touched against the printer device (and received the image and token). For example, the user may receive the image and token by tapping their own display device against their friend's printer device and then may subsequently (e.g. the next day) access the album via their smartphone by reading the token from their display device. As described above, the token may have a limited period of time when it is valid and so the user may not be able to access the album if they wait too long before using the token.

In another example, a user may upload an image and permission token for one or more music tracks to a display device and then give the display device to another user as a gift. The receiving user can then download the music tracks to their smartphone using the token stored in the display device that they were given.

The content which the permission token grants access to may be static content (i.e. content that does not change between the generating of the permission token and the subsequent accessing of that content using the token) or the content may be dynamic (i.e. such that it updates over time and so may not be exactly the same when the token is generated and when the content is subsequently accessed by a user who has received the token). In an example, the content may be details of a user's itinerary (including flight details, current status for the flight, weather at the destination, etc.) and the image may be an image which is representative of that itinerary (e.g. a boarding card for the flight). By reading the permission token from the display device showing the image, a user may be able to access more detailed and up-to-date information about their itinerary.

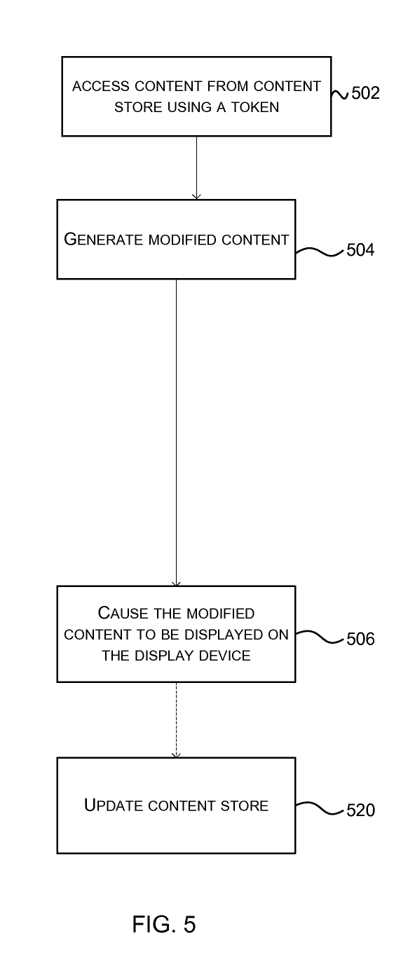

In various examples, when a token is used and the content accessed from the content store 125 (e.g. using computing device 110), this may trigger the modification of the displayed image, e.g. as shown in FIG. 5. FIG. 5 is a flow diagram showing an example method of operation of the computing device 110 which accesses the content using the token and then this access triggers the modification of the image (e.g. by a content modifying module within the computing device 110). The method comprises accessing the content from the content store 125 using the token (block 502).

Having accessed the content using the token, the method comprises generating modified content (block 504) and this may be implemented by the content modifying module on the computing device 110 or by the display device automatically. The modified content which is generated (in block 504) may be partially the same as the original content (i.e. the content currently being displayed on the electronic paper display) or may be completely different from the original content, whilst still being generated based on that original content. The modified content may also be referred to as derived content. Various examples of the way the modified content may be generated are described below and it will be appreciated that a content modifying device (e.g. the computing device 110 or display device 106) may implement any one or more of these examples.

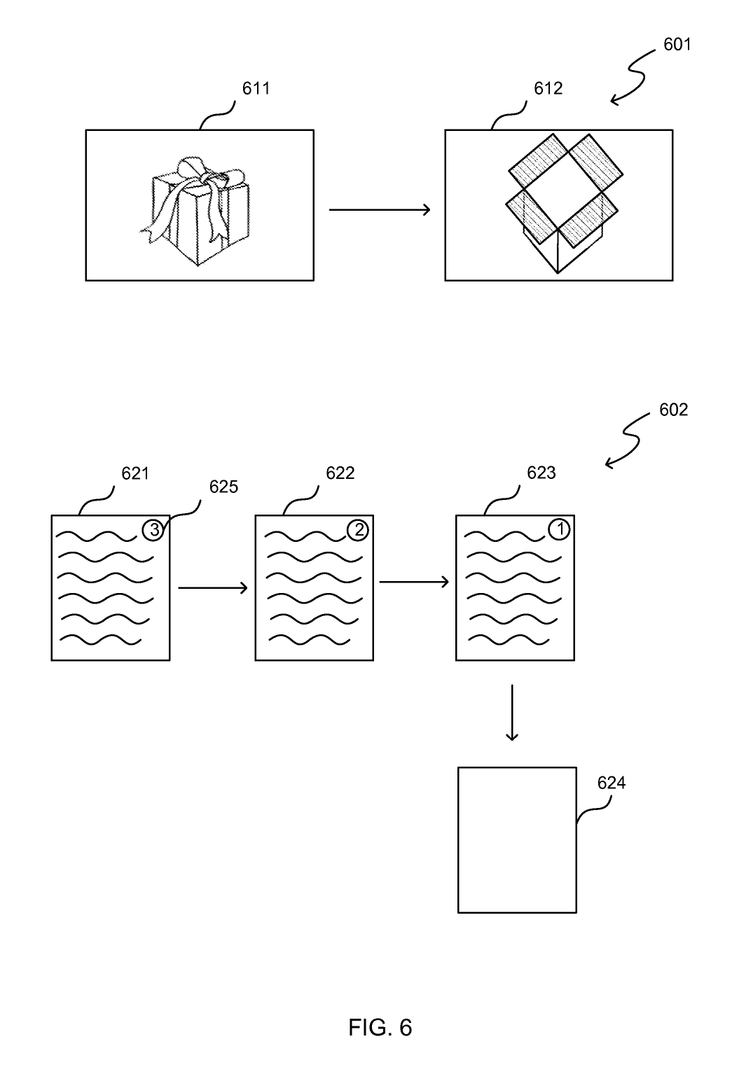

In a first example, the content may be modified (in block 504) automatically according to a pre-defined sequence. For example, an item of content may have an associated state and may be displayed differently based on that associated state, as can be described with reference to FIG. 6. In the first example 601, an item of content may have two pre-defined states 611, 612. If the token (or the content accessed from the content store using the token) indicates that the current content being displayed is the first state 611 of the two pre-defined states, then the modified content which is generated (in block 504) corresponds to the second state 612 of the two pre-defined states. In this example, the changing of the content (from state 611 to state 612) depicts the opening of a gift.

In the second example 602 in FIG. 6, an item of content may have four pre-defined states 621-624. In all but the final state 624, the content is the same except for a number 625 which indicates the number of times the content can be viewed and in each state this number decrements until in the final state 624, the content is no longer visible (e.g. the content has been replaced by a white/black page, become blurred or otherwise been rendered unreadable). It will be appreciated that while this second example uses a number to indicate visually that the content has limited life, this may alternatively be represented in different ways (e.g. with the content becoming gradually fainter in each pre-defined state until it becomes unreadable/invisible without explicitly indicating a number of times it can be viewed). Using this technique, the content displayed on a display device 106 may automatically self-destruct after it has been viewed a pre-defined number of times (where in some examples this pre-defined number of times may only be a single viewing). This can be used as a security mechanism to protect the content being displayed, for example if the content is sensitive in nature (e.g. if it comprises personal data).

In some examples, the generation of modified content (in block 504) may be based on one or more additional parameters in addition to being based on the currently displayed content. An example of such an additional parameter is the number of views (as described above). Another example of an additional parameter on which the generation of modified content may, in part, be based, is the current date and/or time. Use of the date and/or time as an additional parameter enables the content which is displayed to be erased when an expiry date and/or time has passed.

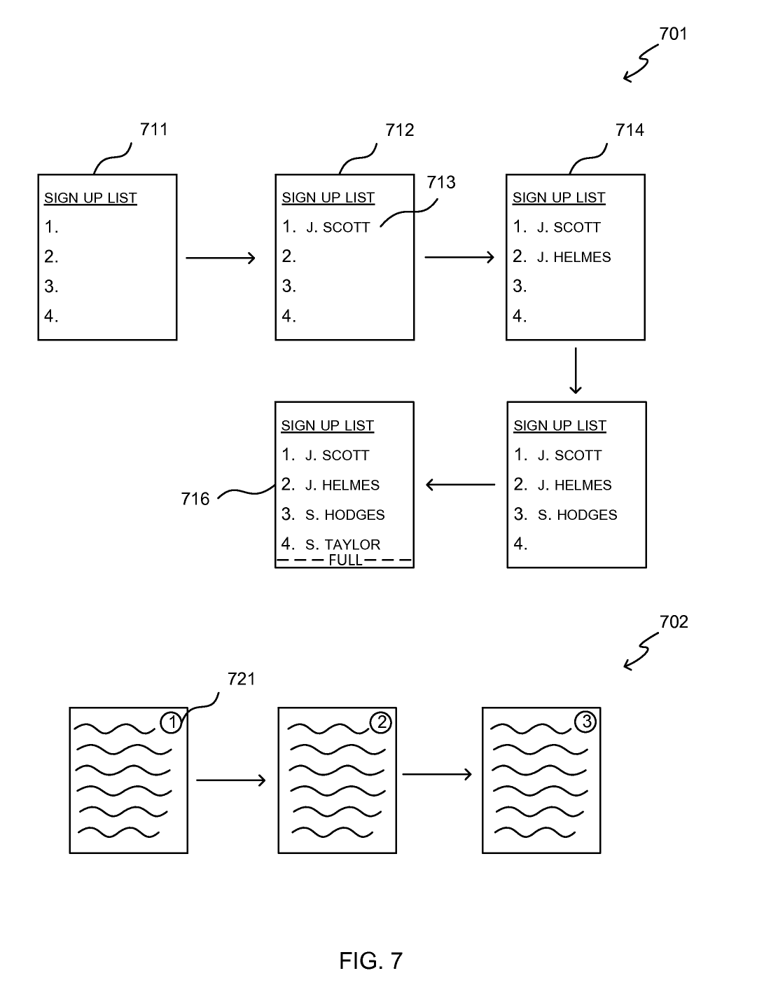

In a second example, the content may be modified (in block 504) automatically in a pre-defined way (e.g. so that the same modification action is performed each time, although the starting content may be different). This is not the same as the first example, as the exact modified content is not pre-defined; however, the way that the modified content is generated is pre-defined. For example, the content may be modified by adding an additional element to the content and/or by removing an element from the content and various examples are shown in FIG. 7. The first example 701 shown in FIG. 7 is an automatic sign-up sheet and the first image is of a blank sign-up sheet 711 which may be initially accessed (in block 502) when a first user accesses the content using a token received from a display device. This results in the generation of modified content 712 (in block 504) which comprises the original content 711 with the addition of the first user's name 713. The modified content 712 is then displayed on the display device (as a consequence of block 506 and as described in more detail below) and the token may be updated or may remain the same. If a second user subsequently accesses the content again modified content 714 is generated (in block 504) by adding a user's name to the content (this time the second user's name is added). As shown in FIG. 7, there may be a limit on the number of times that the content can be updated, for example, when the sign up list becomes full (as shown by modified content 716) and after this it may not be possible to generate further modified content even if a further user tries to access the content using a token.

In the first example 701 in FIG. 7 the user's name may be known by the computing device which modifies the content (and performs block 504) because a user may have specified it within the content modifying application or this data may be stored elsewhere in the computing device 110. In other examples, the data which is added may be another property of the handheld computing device (e.g. a unique identifier associated with the device, the device's telephone number, the location of the device at the time the modification is made, a current mode of operation of the handheld computing device, etc.). In a variation on this example, names may be removed from a displayed list instead of being added.

A second example 702 shown in FIG. 7 is similar to the second example in FIG. 6; however, in this example 702, the number 721 which is added to the content is incremented with each viewing to show the number of times that the content has been accessed. Unlike the example shown in FIG. 6, the different states of the content are not pre-defined but the way that the content is modified each time is pre-defined (e.g. it is not ‘change from image A to image B’ but ‘remove number A from image and replace with number B’).

The modifying of content automatically in a pre-defined way (in block 504) may also be used to implement other features aside from an automatic sign-up sheet (as in example 701) or a count of the number of times content has been viewed (as in example 702). For example, it may be used to automatically update a document with the names of reviewers (who may also be able to add their annotations as described in the next example) and/or names of those who have approved the document (e.g. prior to release of a document), etc. In other examples it may be used to record votes (e.g. the number cast for a particular option and/or the names of those who have voted or have still to vote, with people's names being removed rather than added to a displayed list) or for gaming or mapping applications, for example using computing devices located in fixed positions and which update the content with their location and a time stamp (e.g. in a form of scavenger hunt with competitors racing to collect a certain location stamps on their display device or to generate a map to enable a user to retrace their route at a later time). In a yet further example, it may be used to update a displayed collection of items (e.g. photographs) by adding a new item (e.g. a new photograph) and optionally removing an item (e.g. by removing the oldest photograph to make space for the newly added photograph). In these examples, the item which is added may be associated with or a property of the handheld computing device (e.g. the photograph which was captured or viewed most recently on the handheld computing device or a default image for the handheld computing device).

In various examples, the pre-defined way that the content is modified may be dependent upon a mode of operation of the handheld computing device. For example, one or more computing devices may be configured either in an offline step (i.e. prior to accessing the content in block 502), or in an online step (i.e. by making a user input on the device before accessing the content or before receiving the token) to perform/trigger particular modifications, e.g. “erase”, “increase/decrease” (for content that includes a quantity level), etc.

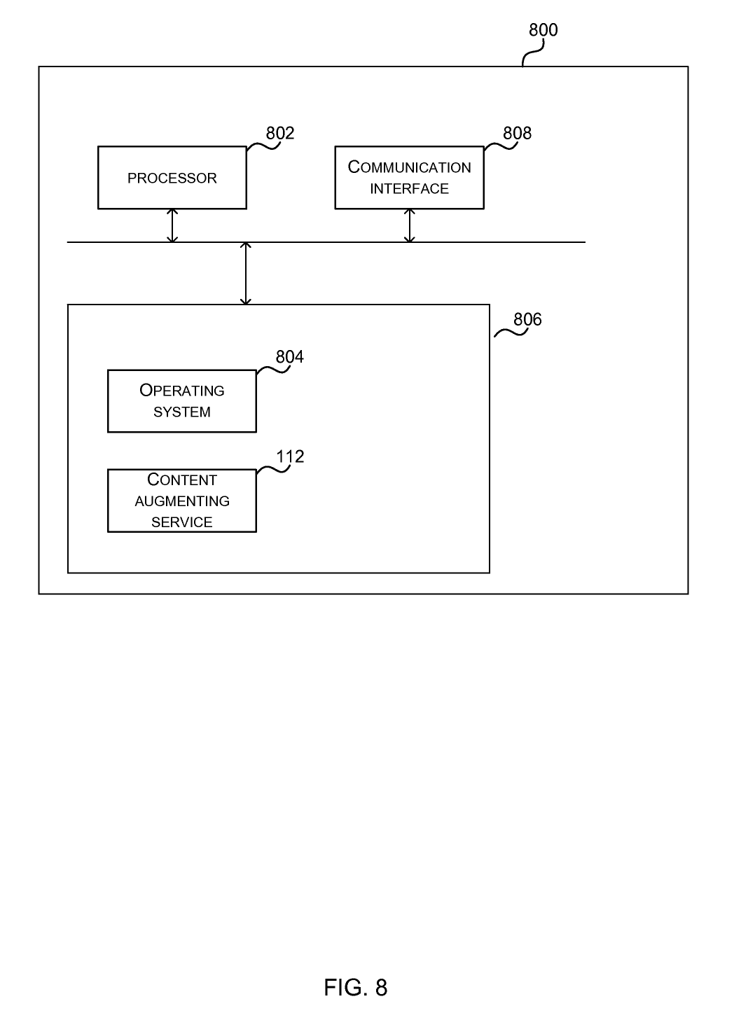

FIG. 8 illustrates various components of an exemplary computing-based device 800 which may be implemented as any form of a computing and/or electronic device, and which may run the content augmenting service 112 described herein.

Computing-based device 800 comprises one or more processors 802 which may be microprocessors, controllers or any other suitable type of processors for processing computer executable instructions to control the operation of the device in order to provide the content augmenting service 112. In some examples, for example where a system on a chip architecture is used, the processors 802 may include one or more fixed function blocks (also referred to as accelerators) which implement a part of the method of operation of the content augmenting service 112 in hardware (rather than software or firmware), e.g. to generate an image (in block 402) or the permission token (in block 404). Platform software comprising an operating system 804 or any other suitable platform software may be provided at the computing-based device to enable application software, including the content augmenting service 112, to be executed on the device. For example, the computing-based device may be a server on which a server operating system is run (directly or within a virtual machine) and the content augmenting service may run as an application on the server operation system.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The computer executable instructions may be provided using any computer-readable media that is accessible by computing based device 800. Computer-readable media may include, for example, computer storage media such as memory 806 and communications media. Computer storage media, such as memory 806, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 806) is shown within the computing-based device 800 it will be appreciated that the storage may be distributed or located remotely and accessed via a network (e.g. network 105) or other communication link (e.g. using communication interface 808).

The computing-based device 800 may also comprise an input/output controller arranged to output display information to a display device which may be separate from or integral to the computing-based device 800 and/or to receive and process input from one or more devices, such as a user input device (e.g. a mouse, keyboard, camera, microphone or other sensor). In some examples the user input device may detect voice input, user gestures or other user actions and may provide a natural user interface (NUI). The input/output controller may also output data to devices other than the display device.

Any of the input/output controller, display device and the user input device may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although the present examples are described and illustrated herein as being implemented in a system in which the content augmenting service 112, content service 102, content generator device 108 and printer device 104 are connected via a network 105 (as shown in FIG. 1), the system described is provided as an example and not a limitation. As those skilled in the art will appreciate, the present examples are suitable for application in a variety of different types of systems and a computing device may act as a content generator and a printer device or a content service and content generator, etc. Furthermore, any suitable communication means may be used by the particular elements shown in FIG. 1 to communicate (e.g. point to point links, broadcast technologies, etc.).

A first further example provides a computing device comprising: a processor; a content augmenting service arranged to generate an image for display on an electronic paper display, the image representing a piece of content stored in a content store and a token providing access to the piece of content in the content store; and a communication interface arranged to transmit the image and the token to a display device comprising the electronic paper display.

The display device in the first further example may comprise the electronic paper display, a contact based conductive digital data and power bus and a processing element configured to drive the electronic paper display, wherein the electronic paper display can only be updated when receiving power via the bus from a power supply external to the display device.

The communication interface in the first further example may be arranged to transmit the image and the token to a printer device for uploading to the display device comprising the electronic paper display and wherein the printer device comprises a power management device configured to supply at least one voltage for driving the electronic paper display to the contact based conductive digital data and power bus in a display device via one or more contacts on an exterior of the printer device and a processing element configured to supply pixel data for the electronic paper display, including pixel data for the image, to the contact based conductive digital data and power bus via two or more contacts on the exterior of the printer device.

A second further example provides a system comprising the computing device according to the first further example and at least one display device, wherein the display device comprises: an electronic paper display and a processing element configured to drive the electronic paper display. The display device may further comprise a contact based conductive digital data and power bus, and wherein the electronic paper display can only be updated when receiving power via the bus from a power supply external to the display device

A third further example provides a computer implemented method of processing content for display on an electronic paper display, the method comprising: generating, by a computing device, an image representing a piece of content stored in a content store; generating, by the computing device, a token providing access to the piece of content in the content store; and transmitting the image and the token from the computing device to a display device comprising the electronic paper display.

In method according to the third further example, the image representing a piece of content may comprise an image corresponding to a portion of the content.

In method according to the third further example, transmitting the image and the token from the computing device to a display device comprising the electronic paper display may comprise: transmitting the image and the token from the computing device to an intermediary device arranged to upload the image and the token to the display device comprising the electronic paper display.

In method according to the third further example, the image may be transmitted from the computing device to the display device via a contact-based bus.

In method according to the third further example, both the image and the token may be transmitted from the computing device to the display device via the contact-based bus.

In method according to the third further example, the display device may comprise: the electronic paper display; a contact based conductive digital data and power bus; and a processing element configured to drive the electronic paper display, wherein the electronic paper display can only be updated when receiving power via the contact-based bus. The display device may further comprise a proximity based wireless device arranged to store the token generated by the computing device and to share the token with a second computing device when in proximity to the display device.

In method according to the third further example, transmitting the image and the token from the computing device to a display device comprising the electronic paper display may comprise: transmitting the image and the token from the computing device to an intermediary device arranged to upload the image and the token to the display device comprising the electronic paper display and wherein the intermediary device comprises: a power management device configured to supply at least one voltage for driving the electronic paper display to the contact based conductive digital data and power bus in a display device via one or more contacts on an exterior of the printer device; and a processing element configured to supply pixel data for the electronic paper display, including pixel data for the image, to the contact based conductive digital data and power bus via two or more contacts on the exterior of the printer device. The processing element in the intermediary device may be further configured to supply the permission token to the display device over the contact based conductive digital data and power bus via two or more contacts on the exterior of the printer device.

In method according to the third further example, the token may be a permission token comprising a unique identifier encoding access permissions for the piece of content.

In method according to the third further example, generating an image representing a piece of content stored in a content store may comprise: generating an image representing a piece of content stored in a content store; and optimizing the image for display on an electronic paper display. Optimizing the image for display on an electronic paper display may comprise: processing the image to enhance text quality and/or processing the image to ensure features of the image satisfy minimum feature sizes and/or optimizing the image for a particular target electronic paper display.

The method according to the third further example may further comprise: overlaying additional information onto the image prior to transmitting it to the display device comprising the electronic paper display.

In method according to the third further example, the additional information may comprise a visual code encoding the token.

A fourth further example provides a system comprising: a computing device running a content augmenting service; and at least one display device; wherein the computing device comprises: a processor; a communication interface; and a memory arranged to store device-executable instructions that, when executed by the processor, direct the computing system to: generate an image representing a piece of content stored in a content store; generate a token providing access to the piece of content in the content store; and transmit, via the communication interface, the image and the token to a display device comprising the electronic paper display, wherein the display device comprises: an electronic paper display; and a processing element configured to drive the electronic paper display.

A fifth further example provides a printer device comprising: a power management device configured to supply at least one voltage for driving an electronic paper display to a contact based conductive digital data and power bus in a display device comprising the electronic paper display via one or more contacts on an exterior of the printer device and a processing element configured to supply pixel data for the electronic paper display, including pixel data for the image, to the contact based conductive digital data and power bus via two or more contacts on the exterior of the printer device, and to upload the token to the display device.

A sixth further example provides a computing device comprising: a means for generating an image for display on an electronic paper display, the image representing a piece of content stored in a content store and a token providing access to the piece of content in the content store; and a means for transmitting the image and the token to a display device comprising the electronic paper display.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computing device comprising:
a processor;
a content augmenting service arranged to
generate an image for display on an electronic paper display, the image representing a piece of content stored in a content store and a token providing access to the piece of content in the content store; and
a communication interface arranged to transmit the image and the token to a display device comprising the electronic paper display.

2. The computing device according to claim 1, wherein the display device comprises the electronic paper display, a contact based conductive digital data and power bus and a processing element configured to drive the electronic paper display, wherein the electronic paper display can only be updated when receiving power via the bus from a power supply external to the display device.

3. The computing device according to claim 1, wherein the communication interface is arranged to transmit the image and the token to a printer device for uploading to the display device comprising the electronic paper display and wherein the printer device comprises a power management device configured to supply at least one voltage for driving the electronic paper display to the contact based conductive digital data and power bus in a display device via one or more contacts on an exterior of the printer device and a processing element configured to supply pixel data for the electronic paper display, including pixel data for the image, to the contact based conductive digital data and power bus via two or more contacts on the exterior of the printer device.

4. A computer implemented method of processing content for display on an electronic paper display, the method comprising:
generating, by a computing device, an image representing a piece of content stored in a content store;
generating, by the computing device, a token providing access to the piece of content in the content store; and
transmitting the image and the token from the computing device to a display device comprising the electronic paper display.

5. The method according to claim 4, wherein the image representing a piece of content comprises an image corresponding to a portion of the content.

6. The method according to claim 4, wherein transmitting the image and the token from the computing device to a display device comprising the electronic paper display comprises:
transmitting the image and the token from the computing device to an intermediary device arranged to upload the image and the token to the display device comprising the electronic paper display.

7. The method according to claim 4, wherein the image is transmitted from the computing device to the display device via a contact-based bus.

8. The method according to claim 7, wherein both the image and the token are transmitted from the computing device to the display device via the contact-based bus.

9. The method according to claim 4, wherein the display device comprises:
the electronic paper display;
a contact based conductive digital data and power bus; and
a processing element configured to drive the electronic paper display, wherein the electronic paper display can only be updated when receiving power via the contact-based bus.

10. The method according to claim 9, wherein the display device further comprises a proximity based wireless device arranged to store the token generated by the computing device and to share the token with a second computing device when in proximity to the display device.

11. The method according to claim 9, wherein transmitting the image and the token from the computing device to a display device comprising the electronic paper display comprises:
transmitting the image and the token from the computing device to an intermediary device arranged to upload the image and the token to the display device comprising the electronic paper display and wherein the intermediary device comprises:
a power management device configured to supply at least one voltage for driving the electronic paper display to the contact based conductive digital data and power bus in a display device via one or more contacts on an exterior of the printer device; and
a processing element configured to supply pixel data for the electronic paper display, including pixel data for the image, to the contact based conductive digital data and power bus via two or more contacts on the exterior of the printer device.

12. The method according to claim 11, wherein the processing element in the intermediary device is further configured to supply the permission token to the display device over the contact based conductive digital data and power bus via two or more contacts on the exterior of the printer device.

13. The method according to claim 4, wherein the token is a permission token comprising a unique identifier encoding access permissions for the piece of content.

14. The method according to claim 4, wherein generating an image representing a piece of content stored in a content store comprises:
generating an image representing a piece of content stored in a content store; and
optimizing the image for display on an electronic paper display.

15. The method according to claim 14, wherein optimizing the image for display on an electronic paper display comprises:
processing the image to enhance text quality.

16. The method according to claim 14, wherein optimizing the image for display on an electronic paper display comprises:
processing the image to ensure features of the image satisfy minimum feature sizes.

17. The method according to claim 14, wherein optimizing the image for display on an electronic paper display comprises:
optimizing the image for a particular target electronic paper display.

18. The method according to claim 4, further comprising:
overlaying additional information onto the image prior to transmitting it to the display device comprising the electronic paper display.

19. The method according to claim 18, wherein the additional information comprises a visual code encoding the token.

20. A system comprising:
a computing device running a content augmenting service; and
at least one display device;
wherein the computing device comprises:
a processor;
a communication interface; and
a memory arranged to store device-executable instructions that, when executed by the processor, direct the computing system to:
generate an image representing a piece of content stored in a content store;
generate a token providing access to the piece of content in the content store; and
transmit, via the communication interface, the image and the token to a display device comprising the electronic paper display,
wherein the display device comprises:
an electronic paper display; and
a processing element configured to drive the electronic paper display.
